(19) United States
(12) Patent Application Publication
(10) Pub. No.: US 2025/0168615 A1
(43) Pub. Date: May 22, 2025

(54) IDENTIFYING UE-TO-UE COMMUNICATION AND RELAYING TRAFFIC VIA UE-TO-UE COMMUNICATION

(71) Applicant: Nokia Technologies Oy, Espoo (FI)

(72) Inventors: Mohamed Amin NASSAR, Munich (DE); Hannu Petri HIETALAHTI, Oulu (FI); Ling Yu, Espoo (FI); Vinh VAN PHAN, Oulu (FI)

(21) Appl. No.: 18/840,038

(22) PCT Filed: Mar. 3, 2022
(86) PCT No.: PCT/EP2022/055447

§ 371 Date: Aug. 20, 2024

(51) Int. Cl. H04W 8/00; H04W 48/20; H04W 76/14; H04W 92/18

(52) U.S. Cl. CPC H04W 8/005; H04W 48/20; H04W 76/14; H04W 92/18

(57) ABSTRACT

An apparatus, in a first user equipment, is provided which comprises at least one processor and at least one memory including computer program code, the at least one memory and the computer program code configured to, with the at least one processor, cause the apparatus at least to perform: receiving a discovery message, wherein the discovery message includes connection information including at least one of a first connection information and a second connection information for a connection to a second user equipment via a relay user equipment, selecting the relay user equipment for the connection to the second user equipment based on the received discovery message, and establishing a direct connection with the selected relay user equipment for the connection to the second user equipment based on the connection information.

### FIELD OF THE INVENTION

The present invention relates to an apparatus, a method and a computer program product for identifying UE-to-UE communication and relaying traffic via UE-to-UE communication.

### RELATED BACKGROUND ART

The following meanings for the abbreviations used in this specification apply:
DDNMF: Direct Discovery Name Management Function
DNN: Data Network Name
E-UTRA: Evolved Universal Terrestrial Radio Access
NR: New Radio
PCF: Policy control function
PDU: Protocol data unit
PLMN: Public Land Mobile Network
ProSe: Proximity Services
RSC: Relay Service Code
S-NSSAI: Single-Network Slice Selection Assistance Information
SSC: Session and Service Continuity
U2N: UE-to-Network
U2U: UE-to-UE
UE: User Equipment

Example embodiments, although not limited to this, relate to direct connections between user equipments (UE). For example, such a direct connection is defined in NR over the PC5 interface. Moreover, also relaying of traffic of a remote UE via an UE-to-network relay UE to a network is possible.

In this way, UEs out of coverage of the network may get access to the network.

Example embodiment aim to further enhance possibilities on how a UE could be enabled to access the network even when having no direct connection to the network via a base station, for example.

### SUMMARY OF THE INVENTION

Example embodiments address this situation aim to provide measures for further improving possibilities for a user equipment to access services such as a connection to a network in case the user equipment is out of coverage of the network.

According to a first aspect, an apparatus, in a first user equipment, is provided, the apparatus comprising: at least one processor and at least one memory including computer program code, the at least one memory and the computer program code configured to, with the at least one processor, cause the apparatus at least to perform: receiving a discovery message, wherein the discovery message includes connection information including at least one of a first connection information and a second connection information for a connection to a second user equipment via a relay user equipment, selecting the relay user equipment for the connection to the second user equipment based on the received discovery message, and establishing a direct connection with the selected relay user equipment for the connection to the second user equipment based on the connection information.

According to a second aspect, a method, in a first user equipment, is provided, the method comprising:
receiving a discovery message, wherein the discovery message includes connection information including at least one of a first connection information and a second connection information for a connection to a second user equipment via a relay user equipment,
selecting the relay user equipment for the connection to the second user equipment based on the received discovery message, and
establishing a direct connection with the selected relay user equipment for the connection to the second user equipment based on the connection information.

The first and second aspects may be modified as follows:

The apparatus of the first aspect or the method of the second aspect may receive the discovery message broadcasted from the relay user equipment. Moreover, the apparatus of the first aspect or the method of the second aspect may monitor for a discovery message including the connection information.

Furthermore, apparatus of the first aspect or the method of the second aspect may send a discovery solicitation message including the connection information, and receive the discovery message from the relay user equipment in response to the discovery solicitation message.

The apparatus of the first aspect or the method of the second aspect may, in establishing the direct connection, send a connection establishment request message including the connection information to the relay user equipment, and receive a connection establishment accept message from the relay user equipment.

The second user equipment may be capable of providing a relay to a service network, and the apparatus of the first aspect or the method of the second aspect may use the connection to the second user equipment in order to communicate with the service network.

The apparatus of the first aspect or the method of the second aspect may use the second connection information for establishing the direct connection to the relay user equipment.

The apparatus of the first aspect or the method of the second aspect may obtain authorization and policies for performing receiving the discovery message from the relay user equipment and establishing the direct connection to the relay user equipment from a network control element.

The apparatus of the first aspect or the method of the second aspect may receive the connection information from the network control element.

The connection information may be preconfigured in the apparatus.

According to a third aspect, an apparatus, in a relay user equipment, is provided, the apparatus comprising at least one processor and at least one memory including computer program code, the at least one memory and the computer program code configured to, with the at least one processor, cause the apparatus at least to perform: transmitting a discovery message, wherein the discovery message includes a connection information for a connection between a first user equipment and a second user equipment via the relay user equipment, and establishing a direct connection with the first user equipment based on the connection information.

According to a fourth aspect, a method, in a relay user equipment, is provided, the method comprising:
transmitting a discovery message, wherein the discovery message includes connection information including at least one of first connection information and second connection information for a connection between a first user equipment and a second user equipment via the relay user equipment, and
establishing a direct connection with the first user equipment based on the connection information.

The third and the fourth aspect may be modified as follows:

The apparatus of the third aspect or the method of the fourth aspect may broadcast the discovery message.

The apparatus of the third aspect or the method of the fourth aspect may receive a discovery solicitation message including the connection information (the at least one of the first connection information and the second connection information) from the first user equipment, and transmit the discovery message to the first user equipment in response to the discovery solicitation message.

The apparatus of the third aspect or the method of the fourth aspect may establish a direct connection with the second user equipment after performing establishing the direct connection with the first user equipment.

The apparatus of the third aspect or the method of the fourth aspect may establish a direct connection with the second user equipment before performing transmitting the discovery message with respect to the first user equipment.

The apparatus of the third aspect or the method of the fourth aspect may establish the direct connection with the second user equipment based on the second connection information.

The second user equipment may be capable of providing a relay to a service network, and the apparatus of the third aspect or the method of the fourth aspect may use the direct connection to the second user equipment in order to relay the communication between the first user equipment and the service network.

The apparatus of the third aspect or the method of the fourth aspect may release a connection with respect to the direct connection to the first user equipment in case of a loss of the direct connection with the second user equipment or a failure of a connection of the second user equipment with the service network.

The apparatus of the third aspect or the method of the fourth aspect may establish the connection between the first user equipment and the service network via the second user equipment such that the second user equipment is transparent to the first user equipment.

According to a fifth aspect, an apparatus, in a network control element, is provided, the apparatus comprising at least one processor and at least one memory including computer program code, the at least one memory and the computer program code configured to, with the at least one processor, cause the apparatus at least to perform: receiving a request for authorization to perform transmitting a discovery message and establishing a direct connection between a first user equipment and a second user equipment via a relay user equipment from the first user equipment or the relay user equipment, and providing authorization and policies for transmitting the discovery message and establishing the direct connection to the first user equipment or the relay user equipment.

According to a sixth aspect, a method, in a network control element, is provided, the method comprising:
receiving a request for authorization to perform transmitting a discovery message and establishing a direct connection between a first user equipment and a second user equipment via a relay user equipment from the first user equipment or the relay user equipment, and
providing authorization and policies for transmitting the discovery message and establishing the direct connection to the first user equipment or the relay user equipment.

The fifth and sixth aspects may be modified as follows:

The apparatus of the fifth aspect or the method of the sixth aspect may provide a connection information including at least one of first connection information and second connection information to the first user equipment or the relay user equipment, the connection information identifying a connectivity service including at least a relay connection between the first user equipment and the second user equipment via the relay user equipment.

The apparatus of the third aspect or the method of the fourth aspect may allocate a Proximity Service (ProSe) application ID and associated proximity service application code for the direct connection to the first user equipment or the relay user equipment.

All aspects described above may be modified as follows:

The first connection information may be relay connection information and the second connection information may be direct connection information.

The at least one of first connection information and second connection information may define a specific service provided in connection with the relay user equipment. The at least one of first connection information and second connection information may define the relay user equipment as a relay user equipment capable of transmitting a discovery message and establishing a direct connection with a second user equipment. The at least one of first connection information and second connection information may be mapped to a plurality of relay service connectivities. The at least one of first connection information and second connection information specifies only the relay user equipment.

For each use case of the connection between the first user equipment and the second user equipment via the relay user equipment at least one of a specific first connection information and a specific second connection information may be defined.

The direct connections between the first user equipment and the relay user equipment and between the relay user equipment and the second user equipment may be PC5 connections, and the discovery message may be a PC5 discovery message.

The at least one of first connection information and second connection information may be an information element in a PC5 connection establishment message.

According to a seventh aspect of the present invention a computer program product is provided which comprises code means for performing a method according to any one of the second, fourth and sixth aspects and/or their modifications when run on a processing means or module. The computer program product may be embodied on a computer-readable medium, and/or the computer program product may be directly loadable into the internal memory of the computer and/or transmittable via a network by means of at least one of upload, download and push procedures.

According to an eighth aspect, an apparatus is provided which comprises:
means for receiving a discovery message, wherein the discovery message includes connection information including at least one of a first connection information and a second connection information for a connection to a second user equipment via a relay user equipment,
means for selecting the relay user equipment for the connection to the second user equipment based on the received discovery message, and
means for establishing a direct connection with the selected relay user equipment for the connection to the second user equipment based on the connection information.

According to a ninth aspect, an apparatus is provided which comprises:
means for transmitting a discovery message, wherein the discovery message includes connection information including at least one of first connection information and second connection information for a connection between a first user equipment and a second user equipment via the relay user equipment, and
means for establishing a direct connection with the first user equipment based on the connection information.

According to a tenth aspect, an apparatus is provided which comprises: means for receiving a request for authorization to perform transmitting a discovery message and establishing a direct connection between a first user equipment and a second user equipment via a relay user equipment from the first user equipment or the relay user equipment, and means for providing authorization and policies for transmitting the discovery message and establishing the direct connection to the first user equipment or the relay user equipment.

The eight to tenth aspects may be modified similar as the first, third and fifth aspects, respectively.

### BRIEF DESCRIPTION OF THE DRAWINGS

These and other objects, features, details and advantages will become more fully apparent from the following detailed description of example embodiments, which is to be taken in conjunction with the appended drawings, in which:

FIG. 1A shows a first UE (UE_1) according to an example embodiment,

FIG. 1B shows a process carried out by the first UE according to the example embodiment,

FIG. 2A shows a relay UE (UE_12) according to an example embodiment,

FIG. 2B shows a process carried out by the relay UE according to the example embodiment,

FIG. 3A shows a PCF/DDNMF 3 according to an example embodiment,

FIG. 3B shows a process carried out by the PCF/DDNMF according to the example embodiment,

FIG. 4 shows a UE-to-UE direct communication architecture (from 3GPP TS 23.304),

FIG. 5 a multi-hop relaying architecture according to an example embodiment,

FIG. 6 shows a sequence diagram for utilizing UE-to-UE communication for relaying traffic through UE-to-Network relay according to an example embodiment, and

FIG. 7 shows an alternative sequence diagram for utilizing UE-to-UE communication for relaying traffic through UE-to-Network relay according to an example embodiment.

### DETAILED DESCRIPTION OF EXAMPLE EMBODIMENTS

In the following, description will be made to example embodiments. It is to be understood, however, that the description is given by way of example only, and that the described example embodiments are by no means to be understood as limiting the present invention thereto.

Before describing example embodiments, in the following, problems of the prior art are discussed in some more detail.

In particular, according to some example embodiments, the case is considered that a remote UE (which is also referred to as first UE or UE_12 in the following), that is in PLMN coverage or out of coverage, may need to communicate with another UE.

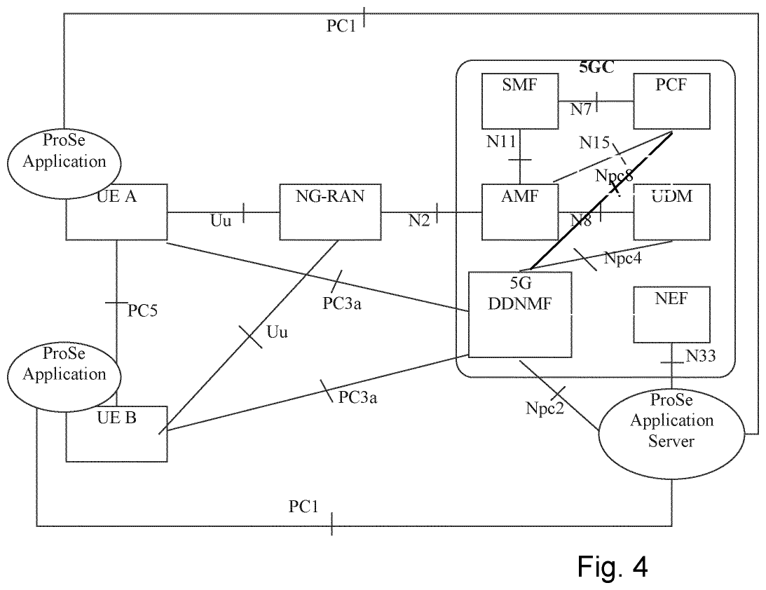

The UE-to-UE communication could be for example public safety workers communication at accident or emergency scene. Even if the outdoor coverage is reasonable, the indoor coverage may be poor, which could risk lives. UE-to-UE communication among the workers can overcome the indoor coverage problem. Another reason for UE-to-UE calls could be the use of caller groups, so the e.g. all firemen can communicate with each other and with their leadership all the time (see also FIG. 4, which shows a UE-to-UE direct communication architecture as defined in 3GPP TS 23.304).

A specific use case for UE-to-UE communication is identified in UE-to-Network relaying over multiple relay hops. If that Remote UE (UE_1) fails to find available a UE-to-Network Relay UE in proximity, the direct discovery procedure fails. In this case, the Remote UE (UE_1) cannot communicate with the network until it finds direct Uu coverage or available UE-to-Network Relay UE (UE_2).

This is the problem which is to be solved according to some example embodiments. In particular, some embodiments are targeted to the practical problem on how to enable the remote UE (UE_1) to discover and setup a PC5 connection with U2U relay UE that is able to provide network connectivity via another U2N relay UE for the remote UE.

Now it can happen that, even if Remote UE (UE_1) and UE-to-Network Relay UE (UE_2) are not within proximity, there could be a third UE that is in proximity of both UE_1 and UE_2. Let's call this interim UE as UE_12 or relay UE. In the following, the UE-to-Network Relay UE (UE_2) is also referred to as second UE.

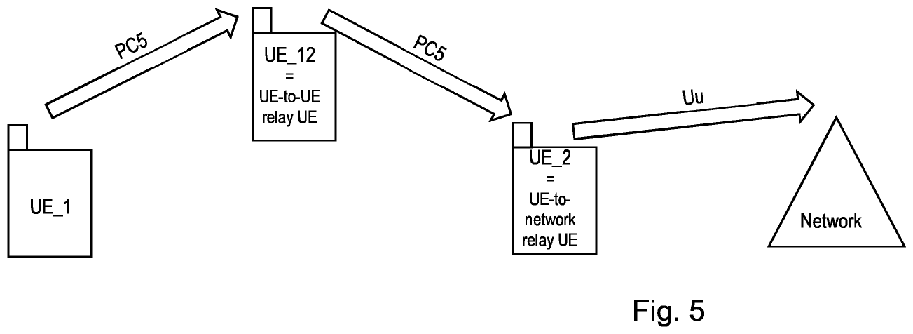

If UE_12 acts as UE-to-UE relay, then the Remote UE (UE_1) can use the relaying service provided by the UE-to-Network Relay UE (UE_2) via UE_12 that acts as a UE-to-UE relay. Please refer to FIG. 5 below for more details about the overall setup.

This is shown in FIG. 5, in which it is illustrated that a connection of the Remote UE (UE_1) with the network is relayed via a PC5 connection to the relay UE (UE_12), further via a PC5 connection to the UE-to-Network relay UE (UE2) and the further via a Uu connection (connection via the Uu interface) to the network.

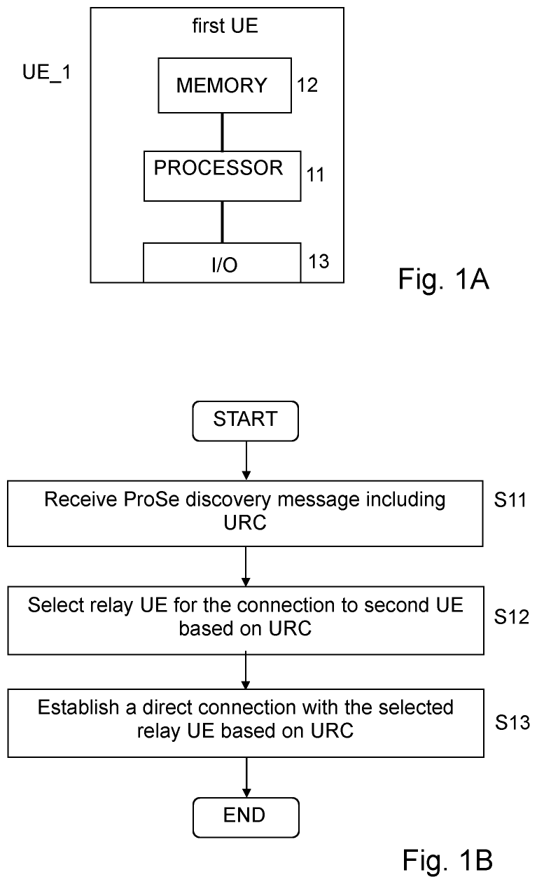

In the following, a general overview of some example embodiments is described by referring to FIGS. 1A, 1B, 2A, 2B, 3A and 3B.

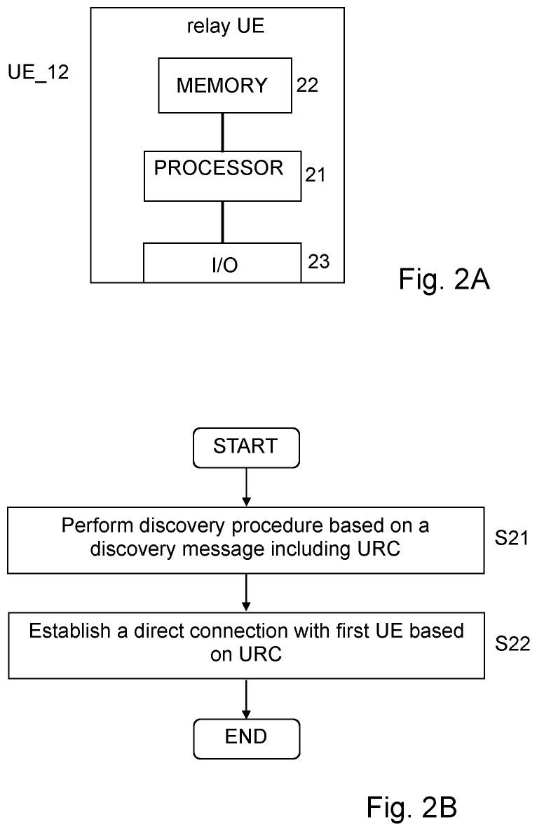

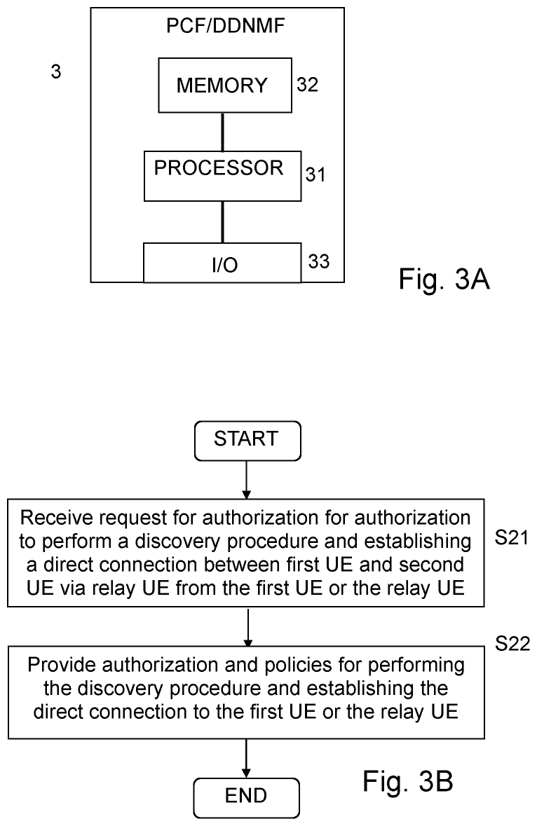

FIG. 1A shows a first user equipment UE_1 according to the present example embodiment. A procedure carried out by UE_1 is illustrated in FIG. 1B. FIG. 2A shows a relay user equipment UE_12 according to the present example embodiment, and FIG. 2B shows a procedure carried out by UE_12. Furthermore, FIG. 3A shows a PCF/DDNMF 3 as an example for a network control element, and FIG. 3C shows a procedure carried out by the PCF/DDNMF 3.

The first user equipment UE_1 shown in FIG. 1A, which is also referred to as a remote UE, comprises at least one processor 11 and at least one memory 12 including computer program code. The at least one processor 11, with the at least one memory 12 and the computer program code, is configured to cause the apparatus to perform: receiving a discovery message, wherein the discovery message includes connection information including at least one of a first connection information and a second connection information for a connection to a second user equipment (e.g., UE_2 shown in FIG. 5) via a relay user equipment (e.g., UE_12 shown in FIG. 2A and in FIG. 5) (as shown in S11 in FIG. 1B), selecting the relay user equipment for the connection to the second user equipment based on the received discovery message (as shown in S12 in FIG. 1B), and establishing a direct connection with the selected relay user equipment for the connection to the second user equipment based on the connection information (as shown in S13 in FIG. 1B).

The relay user equipment UE_12 shown in FIG. 2A comprises at least one processor 21 and at least one memory 22 including computer program code. The at least one processor 21, with the at least one memory 22 and the computer program code, is configured to cause the apparatus to perform: performing a discovery procedure based on a discovery message, wherein the discovery message includes a connection information including at least one of first connection information and second connection information for a connection between a first user equipment (e.g. UE_1) and a second user equipment (e.g., UE_2) via the relay user equipment (S21 in FIG. 2B), and establishing a direct connection with the first user equipment based on the connection information (S22 in FIG. 2B).

The PCF/DDNMF 3 as an example for a network control element shown in FIG. 3A comprises at least one processor 31 and at least one memory 32 including computer program code. The at least one processor 31, with the at least one memory 32 and the computer program code, is configured to cause the apparatus to perform: receiving a request for authorization to perform a discovery procedure and establishing a direct connection between a first user equipment (e.g., UE_1) and a second user equipment (e.g., UE_2) via a relay user equipment (e.g., UE_12) from the first user equipment or the relay user equipment (S31 in FIG. 3B), and providing authorization and policies for performing the discovery procedure and establishing the direct connection to the first user equipment or the relay user equipment (S23 in FIG. 2B).

UE_1, UE_2 and The controller 1 and PCF/DDNMF 3 described above may further comprise I/O units 13, 23, 33 which are capable of transmitting to and receiving from other network elements.

Thus, according to some example embodiments as described above, a relay connection between the first user equipment UE_1 and the second user equipment UE_2 via the relay user equipment UE_12 can easily be provided, namely by using the connection information (i.e., the at least one of first connection information and second connection information) in the discovery procedure.

The connection information may define a specific service provided in connection with the relay user equipment, for example a relay connection with the network, in which the second user equipment provides a relay connection to the network, and the relay user equipment provides a relay connection from the first user equipment to the second user equipment, so that the first user equipment is able to communicate with the network even though it is outside coverage of a base station of the network, for example.

For example, the first connection information may be relay connection information, and the second connection information may be direct connection information.

The relay connection information may indicate information for providing a relay connection to the second user equipment via the relay user equipment.

The direct connection information may indicate information for establishing a direct connection between user equipments and may be a relay service code.

The first connection information (relay connection information) may include a new UE-to-UE relay code (URC), which is described later in more detail.

It is noted that the direct connection between two UEs described above is a direct connection without the need for the network to intermediate messages between the two UEs. For example, such a direct connection can be provided via a PC5 interface between the two UEs.

In the following, some further detailed embodiments are described.

In the following some definitions from 3GPP TS 23.304 V17.1.1 (2022-01) are given, which are helpful for understanding some of the following example embodiments:

5G ProSe-enabled UE: A UE that supports 5G ProSe requirements and associated procedures.

5G ProSe Direct Discovery: A procedure employed by a 5G ProSe-enabled UE to discover other 5G ProSe-enabled UEs in its vicinity based on direct radio transmissions between the two UEs with NR technology.

5G ProSe Direct Communication: A communication between two or more UEs in proximity that are 5G ProSe-enabled, by means of user plane transmission using NR technology via a path not traversing any network node.

5G ProSe UE-to-Network Relay: A 5G ProSe-enabled UE that provides functionality to support connectivity to the network for 5G ProSe Remote UE(s).

As mentioned above, according to some example embodiments, procedures are provided by which a remote UE (UE_1) is enabled to discover and setup a PC5 connection with a U2U relay UE that is able to provide network connectivity via another U2N relay UE for the remote UE.

FIG. 4 shows, as mentioned above, a UE-to-UE communication architecture between UE A and UE B based on Figure 4.2.1-2 in 3GPP TS 23.304.

FIG. 5 shows, as mentioned above, multi-hop relaying of Relay UE's traffic (UE_1) via Relay UE seen by the serving network (UE_2) and via one or more intermediary hops (UE_12). In FIG. 5, the connectivity over PC5 interfaces is direct connection between two UEs without the need for the network to intermediate the PC5 messages between the two UEs.

A procedure according to some example embodiments to set up UE-to-UE connectivity is as follows: UE_1 seeks direct connectivity with another UE UE_12, which is authorized for UE-to-UE communication. Once UE_1 has discovered UE_2 and PC5 communication is set up, that PC5 link can be used for example, for:
UE-to-UE communication (e.g. public safety)
UE_12 relaying UE_1 traffic towards the serving network via another relay UE (UE_2).

The overall setup is shown in FIG. 5. This procedure is applicable for both Layer-2 relaying and Layer-3 relaying. The main proposals of some example embodiments include:

A new UE-to-UE relay code (URC) is introduced to facilitate U2U relay discovery. The introduced URC may be specific for U2U relay discovery. In this option, a new code/value of Relay service code (RSC) should be introduced for utilizing U2U relay to discover U2N relay UE. As another option, the introduced URC may also be used for U2N relay UE via U2U relay discovery. In this option, some of URC values may be defined for this purpose to avoid introducing another new RSC. As a further option, the URC may have some associated RSCs together with it, i.e. the URC maps to more than one RSC, and those RSCs can be known and configured to the Remote UE as part of the policies configuration associated with that URCIn either option, the new URC or RSC may be used by remote UE (e.g. UE_1) or/and U2U relay UE (e.g. UE_12) depending on discovery model A or model B. This new URC or RSC is an example for the first connection information or relay connection information described above.

Furthermore, a new remote UE behaviour for discovering U2N relay UE and U2U relay UE for the connectivity with network is provided. The introduced URC separate with legacy RSC enables remote UE to discovery and identify U2N relay UE and U2U relay UE separately and prioritize the relay UE selection accordingly. Selection of U2U relay UE may be blindly made based on URC that is associated with U2U relay only. Or the selection of U2U relay may be based on at least one of URC and new RSC that is associated with U2U relay UE connecting with U2N relay UE.

It is noted that, as described above, the Remote UE (UE_1) would usually try first to discover a UE-to-Network Relay UE directly. If that fails, then the Relay UE (UE_1) can try to discover a UE-to-UE-relay to use it to reach to a UE-to-Network relay UE (i.e. to follow our proposal here).

It is further noted that according to the prior art, the RSC (Relay Service Code) is used to identify a UE-to-Network Relay UE that has certain specifications, i.e. as can be seen in 3GPP TS 24.554 clause 5.2.5:

The configuration parameters for the role of a ProSe UE-to-network relay UE over PC5 reference point consist of:
( . . . )
f) one or more relay service code(s) for the UE-to-network relay discovery, and for each relay service code:
1) security related content for 5G ProSe relay discovery;
2) an indication of whether the relay service code is offering 5G ProSe layer-2 or layer-3 UE-to-network relay service; and
3) for 5G ProSe layer-3 UE-to-network relay UE, a set of PDU session parameters:
i) PDU Session type;
ii) optionally, DNN;
iii) optionally, SSC Mode;
iv) optionally, S-NSSAI; and
v) optionally, access type preference;
( . . . )

In the following, some more detailed example embodiments are described.

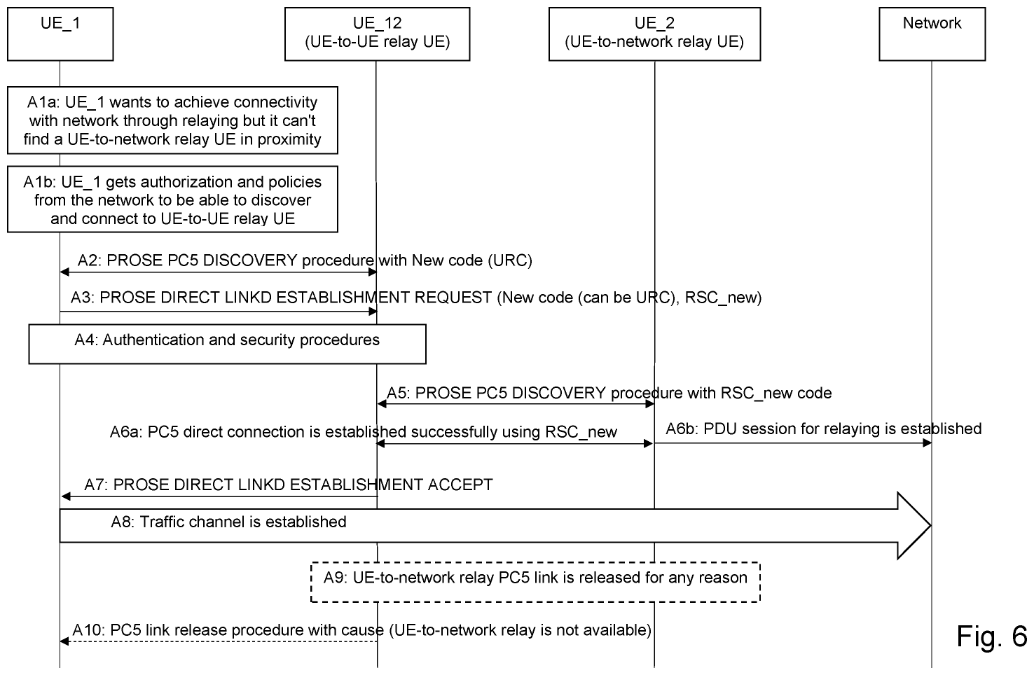

FIG. 6 shows a sequence diagram for utilizing UE-to-UE communication for relaying traffic through UE-to-Network relay. In particular, it shows processes as carried out by the remote UE UE_1, the UE-to-UE relay UE UE_12, the UE-to-network relay UE UE_2 and the network.

As will be described in the following, processes A1-A4 are UE-to-UE connection establishment that can be used as they stand for UE-to-UE communication (for e.g. public safety use case). In relaying use case, processes A1-A4 are pre-requisite UE-to-UE communication setup that enables subsequent UE_1 traffic relaying towards the network via UE_12 and UE_2.

The processes shown in FIG. 6 are described in more detail in the following.

In process A1a in FIG. 6, it is assumed that UE_1 wants to achieve connectivity with another UE using UE-to-UE communication as it wants to reach the network through relaying but it can't find a UE-to-network relay UE in proximity, so it will try first to connect to a UE-to-UE relay.

In process A1b, if UE-to-UE communication is authorized, the DDNMF may allocate ProSe Application ID and associated ProSe Application Code that identifies UE-to-UE communication. If UE_1 can discover UE_12 that supports the same code, then UE-to-UE connection establishment can proceed. It is noted that both Model A discovery and Model B discovery can be supported.

Moreover, in process A1b, if UE-to-Network communication via multiple hops is supported, the DDNMF may allocate another ProSe Application ID and associated ProSe Application Code that identifies the establishment of UE-to-UE communication between UE_1 and UE_12 for the purpose of UE_12 relaying UE_1 traffic (via UE_2). If Restricted Code Suffixes are used, then the DDNMF may interact with ProSe Application Server for Restricted Code Suffix assignment.

It is noted that the process A1b may also be carried out beforehand, i.e. so that the UE_1 has the necessary authorization and policies before it loses connection to the network and is in need to find a UE-to-network relay UE. For example,, the configuration parameters can be pre-configured in the UE (i.e., UE_1).

In process A2, UE_1 would need to listen/provide (depending on whether discovery Model A or Model B is used) in the Discovery messages a new parameter, let's call it “UE-to-UE Relay Code or URC” that indicates it needs to discover a UE-to-UE relay UE and with certain specifications (similar to the “Relay Service Code or RSC” that was used for discovering a UE-to-Network relay UE).

Furthermore, in process A3 shown in FIG. 6, UE_1 would need possibly to indicate a new RSC (e.g. if URC was not sufficient as described in options B) and C) above), let's call it RSC_new, in the PC5 Direct Connection Establishment with UE_12, where the RSC_new is used by UE_12 to find and connect to UE_2, if available (i.e. RSC_new has different purpose than RSC that is defined currently in the specifications) From protocol signalling point of view, the URC and RCS_new can be new Information Elements (IEs) in the PC5 Connection Establishment message. There can be different codes for different UE-to-UE communication use cases, so that plain UE-to-UE communication (for public safety) can be distinguished from UE-to-UE communication for relaying the traffic to another UE or to a U2N relay.

It is noted that RSC_new is an example for the second connection information or direct connection information.

There can be different codes for different UE-to-UE communication use cases, so that plain UE-to-UE communication (for public safety) can be distinguished from UE-to-UE communication for relaying the traffic to another UE or to a U2N relay.

Some possibilities for how the URC value can be defined and the possible solutions are as following:

A) First option: The URC value can by itself define a UE-to-UE Relay UE (UE_12) that is capable of making a PC5 Discovery+PC5 connection with another certain UE-to-Network Relay UE (UE_2), i.e. as if the URC value itself maps to a certain fixed RSC. In that case, the Remote UE (UE_1) doesn't need to provide an additional parameter to indicate which RSC it wishes to find and use).

B) Second option: The URC has some associated RSCs together with it, i.e. the URC maps to more than one RSC, and those RSCs can be known and configured to the Remote UE as part of the policies configuration associated with that URC (similar to what is done in 3GPP TS 24.554 clause 5.2.5). In that case, the Remote UE (UE_1) would need to indicate to UE_12 which RSC it wants to use during the PC5 connection phase (process A3 in FIG. 6).

C) Third option: The URC is specific only to the UE-to-UE relay UE (i.e. is used to discover and connect to the U2U relay UE), and is not associated with certain RSCs (i.e. not associated with certain U2N relay in the background). In that case the Remote UE (UE_1) would also need to indicate to UE_12 the RSC it wants to use during the PC5 connection phase (process A3 in FIG. 6), where UE_12 would need to check if it supports this RSC_new to find a U2N relay UE and connect to it.

It is noted that, in options B) and C) above, the RCS_new that is indicated in the PC5 Connection Request message is not the same as the RCS that exists in the same message today. This is because RSC_new doesn't mean to UE_12 that “please act as U2N relay UE with certain RSC to relay the traffic to the network”, but instead it means to UE_12 that “you can still act as U2U relay but please find a certain U2N with certain RSC that can relay the traffic to the network”.

In process A4, authentication and security procedures are carried out.

Thereafter, in process A5, UE_12 performs a ProSe discovery procedure with RSC_new in order to find a UE-to-network relay UE, i.e., UE_2. After a successful discovery, in process A6a a PC5 direct connection is established successfully using RSC_new, and in process A6B a PDU session with the network is established. Thus, in process A7 UE_12 sends a ProSe direct link establishment accept message to UE_1. Thereafter, in process A8 the traffic channel is established.

It is noted that processes A5, A6 and A7 are only applicable if UE_1 was seeking relayed communication via UE_12: UE_12, before confirming the successful PC5 connection Establishment to UE_1, would start to discover a UE-to-network relay UE using RSC_new till it finds UE_2 then UE_12 makes a PC5 connection with UE_2 using the RSC_new. Once this is done successfully, UE_12 confirms the successful PC5 connection to UE_1.

Now, the full link is established (from UE_1 till the Network, going through UE_12 and UE_2) and UE_1 can start sending its traffic to the network (process A8).

After process A8, the UE_1 supports the role of Remote UE towards UE_12. The UE_12 routes the traffic from UE_1 to UE_2 and vice versa. Both signalling and user plane traffic is relayed via interim hop in UE_12. UE_12 supports the role of Remote UE towards UE_2, but instead of producing the Remote UE signalling and data itself, it only relays signalling and data that it receives from UE_1. Neither network nor UE_2 see the multi-hop functionality at all, as UE_12 acts in the role of the Remote UE on behalf of UE_1 that provides the signalling and data contents and responds to authentication, if requested by the network.

Processes A9 and A10: If UE_12 can't find a UE-to-Network relay UE OR if the PC5 link between UE_12 and UE_2 is dropped/released (process A9), then UE_12 can report those failure cases/release the connection to UE_1 with a new error cause (for example: cause: UE-to-Network relay UE is not available) (process A10).

In the following, model A discovery and model B discovery mentioned above are shortly described. In model A discovery, UE_12 is the announcing UE, i.e. the UE that broadcasts the ProSe PC5 discovery message for Announcement. UE_1 is the is the monitoring UE, i.e. the UE that receives the discovery message and find that it matches its need, then hence UE_1 tries to Establish a PC5 direct connection with UE_12.

In Model B, UE_1 starts with sending the ProSe PC5 discovery message for Solicitation to UE_12, asking for a reply. UE_12 replies back to UE_1 with the ProSe PC5 discovery message for Response to UE_1. After that UE_1 can proceed and establish the PC5 connection with UE_12.

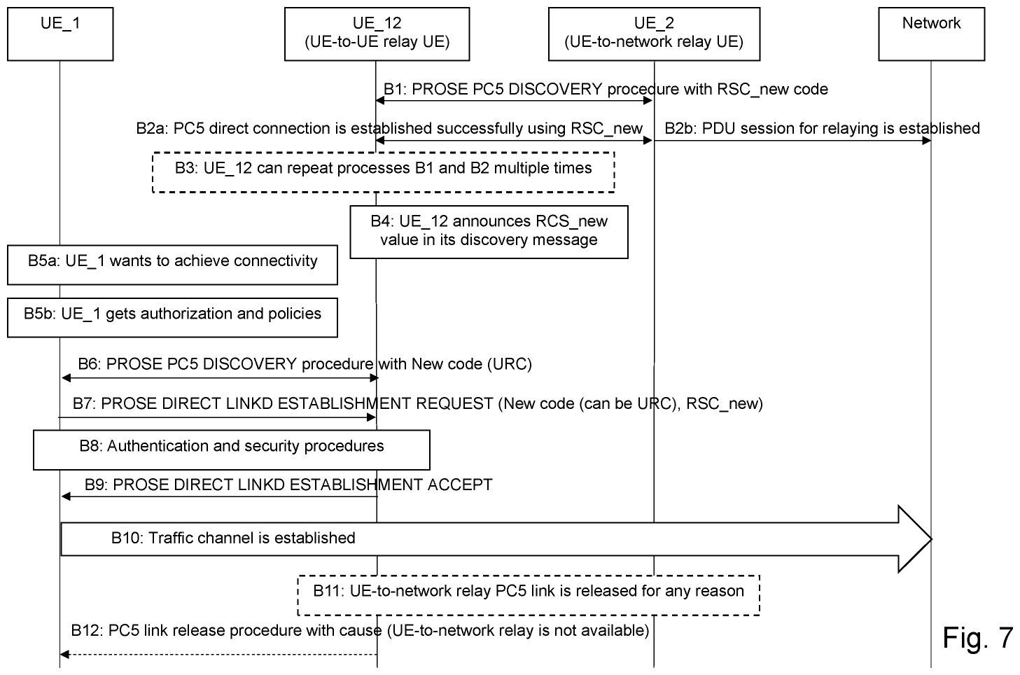

In the following, another example embodiment is described, according to which it is possible to reduce latency. According to this example embodiment, UE_12 proactively discovers (and possibly connects to) UE_2 early for certain RSC_new, and indicate that to UE_1 during the discovery phase (hence less latency in the end-to-end connection setup). This can happen when for example UE_12 discovers and connects to UE_2 early for its own relaying. This makes UE_12 ready once it gets a request for connection for the sake of relaying traffic to network with the same certain RSC_new. In this case, UE_12 can announce the RSC_new together with the URC in its Discovery messages (or can announce the URC only if URC maps to certain fixed RSC as described in option A) above). This alternative solution is shown in FIG. 7.

Thus, the sequence shown in FIG. 7 starts with process B1, in which (similar to process A5 in FIG. 6), UE_12 performs a ProSe discovery procedure with RSC_new in order to find a UE-to-network relay UE, i.e., UE_2. After a successful discovery, in process B2a (corresponding to process A6a) a PC5 direct connection is established successfully using RSC_new, and in in process B2b (corresponding to process A6b), a PDU session with the network is established.

In process B3 it is indicated that UE_12 may repeat processes B1 and B2 multiple times, in order to establish connections for different RSCs (RSC_new1, RSC_new2, . . . etc.) to be ready for any request with a certain RSC from UE_1 or any other remote UE.

In process B4, UE_12 announces RCS_new value in its discovery message (besides the URC value, declaring that it is capable of connecting to a UE-to-network relay UE (UE_2).

Processes B5a and B5b are similar to processes A1a and A1b of FIG. 6. That is, in process B5a, it is assumed that UE_1 wants to achieve connectivity with the network through relaying, but it cannot find a UE-to-network relay UE in proximity. In process B5b, UE_1 gets need authorization and policies from the network (PCF, 5G DDNMF) to be able to discover and connect to UE-to-UE relay UE.

In process B6 (corresponding to process A2), UE_1 performs a ProSe PC5discovery procedure with the new code URC. After a successful discovery of UE_12 (i.e, when model A discovery is applied, after having received a discovery message including the code URC broadcasted by UE_12), in process B7, UE_1 sends a ProSe direct link establishment request including the new code (URC and/or RSC_new described in the following) to UE_12. In process B8 (corresponding to process A4), authentication and security procedures are carried out.

Since UE_12 has already established a direct PC5 connection with UE_2, it sends in process B9 a ProSe direct link establishment accept message to UE_1. Thereafter, in process B10 the traffic channel is established.

Similar to processes A9 and A10 in FIG. 6, it is assumed in process B11 that the UE-to-network relay PC5 link is released for any reason. In response to this, in process B12 UE_12 performs a PC5 link release procedure with cause (namely that the UE-to-network relay is not available).

Another alternative is that, in FIG. 7, the UE_12 can perform processes B2a and B2b only after it gets the connection establishment request from UE_1, i.e. after process B7. That is, in this alternative, the UE_12 may carry out the ProSe discovery procedure beforehand, but establishes a PC5 direct connection only after it has received a corresponding request from UE_1.

Thus, according to example embodiments, the following advantages are achieved:

The solution according to example embodiments enables UE_1 to achieve UE-to-UE connectivity for multiple use cases, including pure UE-to-UE (for e.g. public safety) and relayed multi-hop communication with the network even if there is no UE-to-Network relay UE (UE_2) within proximity of UE_1.

Moreover, the user experience can be enhanced, instead of waiting for a UE-to-Network relay UE for a long time.

Furthermore, the solution according to some example embodiments may re-use the existing 5G ProSe architecture to a great extent. UE_12 can act as back-to-back agent where it plays the role of UE-to-UE Relay UE towards the Remote UE (UE_1) and the role of Remote UE towards the UE-to-Network Relay UE (UE_2)). Both Relay UE and Remote UE roles are specified, so UE_12 only needs to join these two together.

The above-described example embodiments are only examples and may be modified.

Names of network elements, protocols, and methods are based on current standards. In other versions or other technologies, the names of these network elements and/or protocols and/or methods may be different, as long as they provide a corresponding functionality.

In general, the example embodiments may be implemented by computer software stored in the memory (memory resources, memory circuitry) 12, 22, 32 and executable by the processor (processing resources, processing circuitry) 11, 21, 31 or by hardware, or by a combination of software and/or firmware and hardware.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory (ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

The memory (memory resources, memory circuitry) 12, 22, 32 may be of any type suitable to the local technical environment and may be implemented using any suitable data storage technology, such as semiconductor based memory devices, magnetic memory devices and systems, optical memory devices and systems, fixed memory and removable memory, and non-transitory computer-readable media. The processor (processing resources, processing circuitry) 11, 21, 31 may be of any type suitable to the local technical environment, and may include one or more of general purpose computers, special purpose computers, microprocessors, digital signal processors (DSPs) and processors based on a multi core processor architecture, as non-limiting examples.

It is to be understood that the above description is illustrative of the invention and is not to be construed as limiting the invention. Various modifications and applications may occur to those skilled in the art without departing from the true spirit and scope of the invention as defined by the appended claims.

1. An apparatus, in a first user equipment, comprising:
at least one processor and at least one memory including computer program code, the at least one memory and the computer program code configured to, with the at least one processor, cause the apparatus at least to perform:
receiving a discovery message, wherein the discovery message includes connection information including at least one of a first connection information and a second connection information for a connection to a second user equipment via a relay user equipment, wherein the second user equipment is capable of providing a relay to a service network,
selecting the relay user equipment for the connection to the second user equipment based on the received discovery message,
establishing a direct connection with the selected relay user equipment for the connection to the second user equipment based on the connection information; and
using the connection to the second user equipment to communicate with the service network.

2. The apparatus according to claim 1, wherein the at least one memory and the computer program code are configured to, with the at least one processor, cause the apparatus to further perform:
receiving the discovery message broadcasted from the relay user equipment.

3. The apparatus according to claim 1, wherein the at least one memory and the computer program code are configured to, with the at least one processor, cause the apparatus to further perform:
monitoring for a discovery message including the connection information.

4. The apparatus according to claim 1, wherein the at least one memory and the computer program code are configured to, with the at least one processor, cause the apparatus to further perform:
sending a discovery solicitation message including the connection information, and
receiving the discovery message from the relay user equipment in response to the discovery solicitation message.

5. The apparatus according to claim 1, wherein the at least one memory and the computer program code are configured to, with the at least one processor, cause the apparatus to further perform:
in establishing the direct connection,
sending a connection establishment request message including the connection information to the relay user equipment, and
receiving a connection establishment accept message from the relay user equipment.

6. (canceled)

7. The apparatus according to claim 1, wherein the discovery message includes the first connection information, and the at least one memory and the computer program code are configured to, with the at least one processor, cause the apparatus to further perform:
using the second connection information for establishing the direct connection to the relay user equipment.

8. The apparatus according to claim 1, wherein the at least one memory and the computer program code are configured to, with the at least one processor, cause the apparatus to further perform:
obtaining authorization and policies for performing receiving the discovery message from the relay user equipment and establishing the direct connection to the relay user equipment from a network control element; and
receiving the connection information from the network control element.

9-10. (canceled)

11. An apparatus, in a relay user equipment, comprising:
at least one processor and at least one memory including computer program code, the at least one memory and the computer program code configured to, with the at least one processor, cause the apparatus at least to perform:
transmitting a discovery message, wherein the discovery message includes a connection information for a connection between a first user equipment and a second user equipment via the relay user equipment, wherein is capable of providing a relay to a service network,
establishing a direct connection with the first user equipment based on the connection information; and
using the direct connection to the second user equipment in order to relay the communication between the first user equipment and the service network.

12. The apparatus according to claim 11, wherein the at least one memory and the computer program code are configured to, with the at least one processor, cause the apparatus to further perform:
broadcasting the discovery message.

13. The apparatus according to claim 11, wherein the at least one memory and the computer program code are configured to, with the at least one processor, cause the apparatus to further perform:
receiving a discovery solicitation message including the connection information from the first user equipment, and
transmitting the discovery message to the first user equipment in response to the discovery solicitation message.

14. The apparatus according to claim 11, wherein the at least one memory and the computer program code are configured to, with the at least one processor, cause the apparatus to further perform:
establishing a direct connection with the second user equipment after performing establishing the direct connection with the first user equipment.

15. The apparatus according to claim 11, wherein the at least one memory and the computer program code are configured to, with the at least one processor, cause the apparatus to further perform:
establishing a direct connection with the second user equipment before performing transmitting the discovery message with respect to the first user equipment.

16. The apparatus according to claim 11, wherein the at least one memory and the computer program code are configured to, with the at least one processor, cause the apparatus to further perform:
establishing the direct connection with the second user equipment based on the second connection information.

17-19. (canceled)

20. An apparatus, in a network control element, comprising:
at least one processor and at least one memory including computer program code, the at least one memory and the computer program code configured to, with the at least one processor, cause the apparatus at least to perform:
receiving a request for authorization to perform transmitting a discovery message and establishing a direct connection between a first user equipment and a second user equipment via a relay user equipment from the first user equipment or the relay user equipment, and
providing authorization and policies for transmitting the discovery message and establishing the direct connection to the first user equipment or the relay user equipment.

21. The apparatus according to claim 20, wherein the at least one memory and the computer program code are configured to, with the at least one processor, cause the apparatus to further perform:
providing a connection information including at least one of first connection information and second connection information to the first user equipment or the relay user equipment, the connection information identifying a connectivity service including at least a relay connection between the first user equipment and the second user equipment via the relay user equipment.

22. The apparatus according to claim 20, wherein the at least one memory and the computer program code are configured to, with the at least one processor, cause the apparatus to further perform:
allocating a Proximity Service (ProSe) application ID and associated proximity service application code for the direct connection to the first user equipment or the relay user equipment.

23. The apparatus according to claim 1, wherein
the first connection information is relay connection information and the second connection information is direct connection information.

24. The apparatus according to claim 1, wherein
the at least one of first connection information and second connection information defines a specific service provided in connection with the relay user equipment, or
the at least one of first connection information and second connection information defines the relay user equipment as a relay user equipment capable of transmitting a discovery message and establishing a direct connection with a second user equipment, or
the at least one of first connection information and second connection information is mapped to a plurality of relay service connectivities, or
the at least one of first connection information and second connection information specifies only the relay user equipment.

25. (canceled)

26. The apparatus according to claim 1, wherein the direct connections between the first user equipment and the relay user equipment and between the relay user equipment and the second user equipment are PC5 connections, and the discovery message is a PC5 discovery message.

27. The apparatus according to claim 1, wherein the at least one of first connection information and second connection information is an information element in a PC5 connection establishment message.

28-56. (canceled)
